(19) United States
(12) Patent Application Publication
(10) Pub. No.: US 2025/0174734 A1
(43) Pub. Date: May 29, 2025

(54) ELECTROCHEMICAL DEVICE AND ELECTRONIC DEVICE

(71) Applicant: Xiamen Ampace Technology Limited, Xiamen (CN)

(72) Inventors: Yunqi LIU, Xiamen (CN); Shenpeng ZHANG, Xiamen (CN)

(73) Assignee: Xiamen Ampace Technology Limited, Xiamen (CN)

(21) Appl. No.: 19/039,914

(22) Filed: Jan. 29, 2025

Related U.S. Application Data
(63) Continuation of application No. PCT/CN2022/109011, filed on Jul. 29, 2022.

(51) Int. Cl. H01M 10/0587; H01M 50/417; H01M 50/434; H01M 50/451; H01M 50/463

(52) U.S. Cl. CPC H01M 10/0587; H01M 50/417; H01M 50/434; H01M 50/451; H01M 50/463

(57) ABSTRACT

An electrochemical device includes a positive electrode, a negative electrode, and a separator located between the positive electrode and the negative electrode. A first surface of the positive electrode has a concave region, a second surface of the positive electrode has a convex region corresponding to the concave region, and a gap is formed between the positive electrode and the negative electrode via the convex region, or a gap is formed between the first surface of the positive electrode and the negative electrode via the concave region.

### CROSS-REFERENCE TO RELATED APPLICATIONS

This application is a continuation application of International Application No. PCT/CN2022/109011, filed on Jul. 29, 2022, the contents of which is incorporated herein by reference in its entirety.

### TECHNICAL FIELD

Some embodiments of this disclosure relate to the field of electrochemical technologies, and particularly to an electrochemical device and an electronic device.

### BACKGROUND

Electrochemical devices such as ion batteries have advantages such as good rate performance, light weight, long cycle life, no memory effect, and good stability, and are widely used. Electrochemical devices usually swell during use, and especially negative electrodes swell significantly. Such swelling may lead to a shorted cycle life.

### SUMMARY

This application provides an electrochemical device and an electronic device. A gap is created between a positive electrode and a negative electrode to reserve a swelling space for the negative electrode, thereby releasing the cyclic swelling force, improving the cycling performance.

Some embodiments of this application provide an electrochemical device, including a positive electrode, a negative electrode, and a separator located between the positive electrode and the negative electrode. A first surface of the positive electrode has a concave region, a second surface of the positive electrode has a convex region corresponding to the concave region, and a gap is formed between the second surface of the positive electrode and the negative electrode via the convex region, or a gap is formed between the first surface of the positive electrode and the negative electrode via the concave region. The gap between the positive electrode and the negative electrode buffers the swelling of the negative electrode, releasing the swelling force during the cycling process of the negative electrode, thereby avoiding deformation of the electrochemical device and improving the cycling effect. Additionally, the concave region in the first surface of the positive electrode and the gap can absorb the electrolyte to increase the amount of the electrolyte between layers, improving the electrolyte retention between layers, and facilitating the cycling performance of the electrochemical device.

In some embodiments of this application, the thickness of the negative electrode before formation is h₀, and the thickness of the negative electrode after formation is h₁. A height of the convex region protruding out of the peripheral zone of the convex region in a thickness direction Y of the positive electrode is h₂, and a swelling rate of the negative electrode is δ, meeting h₂≥h₀×δ. The swelling rate δ is related to the property of a negative electrode active material. For example, graphite typically has a swelling rate of 8% to 12%. After formation, the thickness h₁ of the negative electrode and height h₂ of the convex region protruding out of the peripheral zone of the convex region in the thickness direction of the positive electrode meet 0.01h₁≤h₂≤0.03h₁. In some embodiments, the height h₂ of the convex region protruding out of the peripheral zone of the convex region in the thickness direction of the positive electrode meets 0.01h₁≤h₂≤0.02h₁. In some embodiments, the thickness h₁ of the negative electrode is 100 μm to 180 μm. In some embodiments, the height h₂ of the convex region protruding out of the peripheral zone of the convex region in the thickness direction of the positive electrode is 2 μm to 40 μm.

The positive electrode, the negative electrode, and the separator are wound to form a wound structure; and the wound structure includes a main body portion and bending portions located on two sides of the main body portion. In some embodiments, on the main body portion, a height of the convex region on the second surface protruding out of the peripheral zone of the convex region on the second surface is h₂. In some embodiments, on the bending portion, a height h₂ of the convex region protruding out of a peripheral zone of the convex region in a thickness direction of the positive electrode is 2 μm to 30 μm. In some embodiments, a height of the convex region located on the bending portion and protruding out of a peripheral zone of the convex region in a thickness direction of the positive electrode is 4 times to 10 times a height of the convex region located on the main body portion and protruding out of a peripheral zone of the convex region in the thickness direction of the positive electrode. In some embodiments, the above range allows the cyclic swelling force of the electrochemical device to be well released, avoiding deformation of the electrochemical device. In some embodiments of this application, a height of the convex region protruding out of a peripheral zone of the convex region in a thickness direction Y of the positive electrode is 2 μm to 20 μm.

In some embodiments of this application, on the main body portion, the height h₂ of the convex region protruding out of the peripheral zone of the convex region in the thickness direction of the positive electrode is 2 μm to 10 μm. In some embodiments, on the main body portion, the height h₂ of the convex region protruding out of the peripheral zone of the convex region in the thickness direction of the positive electrode is 2 μm to 5 μm. In some embodiments, on the bending portion, the height h₂ of the convex region protruding out of a peripheral zone of the convex region in a thickness direction of the positive electrode is 5 μm to 30 μm. In some embodiments, on the bending portion, the height h₂ of the convex region protruding out of a peripheral zone of the convex region in a thickness direction of the positive electrode is 10 μm to 30 μm.

In some embodiments of this application, a ceramic layer is provided on a surface of the separator, thereby improving the safety. In some embodiments of this application, the separator includes at least one of polypropylene, polyethylene, or a composite film of polypropylene and polyethylene. In some embodiments of this application, the thickness h₃ of the separator is 3 μm to 30 μm, thereby ensuring the safety and ion conduction efficiency. In some embodiments of this application, peeling strength between the separator and the positive electrode is less than 0.5 N/m, thereby protecting the separator. In some embodiments of this application, the peeling strength between the separator and the positive electrode is 0 N/m.

In some embodiments of this application, a density of the convex region on the second surface is from 7 per square centimeter to 60 per square centimeter. In some embodiments of this application, on the main body portion, a density of the convex region on the second surface is from 8 per square centimeter to 50 per square centimeter. In some embodiments, on the bending portion, the density of the convex region on the second surface is from 8 per square centimeter to 40 per square centimeter. In some embodiments, on the main body portion, the density of the convex region on the second surface is from 8 per square centimeter to 30 per square centimeter. In some embodiments, on the main body portion, the density of the convex region on the second surface is from 8 per square centimeter to 20 per square centimeter.

In some embodiments of this application, at least two convex regions are provided and the at least two convex regions are evenly distributed on the second surface, thereby reducing stress concentration. In some embodiments of this application, the convex region is dot-shaped, stripe-shaped, or polygonal shaped. In some embodiments of this application, the positive electrode, the negative electrode, and the separator are wound to form a wound structure. The wound structure includes a main body portion and bending portions located on two sides of the main body portion. In the main body portion, a surface of the negative electrode facing the positive electrode is a plane surface, and in the bending portion, a surface of the negative electrode facing the positive electrode is an arc surface, thereby reducing the probability of the separator being damaged.

Some embodiments of this application further provide an electronic device including the electrochemical device according to any one of the foregoing embodiments.

In some embodiments of this application, the first surface of the positive electrode of the electrochemical device has a concave region, and the second surface of the positive electrode has a convex region corresponding to the concave region. A gap is formed between the positive electrode and the negative electrode via the convex region, or a gap is formed between the first surface of the positive electrode and the negative electrode via the concave region. This reserves a swelling space for the negative electrode and releases the cyclic swelling force, alleviating or avoiding deformation caused by cyclic swelling, increasing the electrolyte retaining amount, and improving the cycling performance.

### BRIEF DESCRIPTION OF DRAWINGS

With reference to the accompanying drawings and the detailed embodiments below, the above and other features, advantages, and aspects of some embodiments of this disclosure will become more apparent. Throughout the drawings, the same or similar reference numbers indicate same or similar elements. It should be understood that the drawings are illustrative and the components and elements are not necessarily drawn to scale.

FIG. 1 is a film structure diagram of an electrochemical device according to some embodiments.

FIG. 2 is a schematic diagram of a first surface of a positive electrode of an electrochemical device according to some embodiments.

FIG. 3 is a schematic diagram of a second surface of a positive electrode of an electrochemical device according to some embodiments.

FIG. 4 is a schematic diagram of an electrochemical device according to some embodiments.

FIG. 5 is a film structure diagram of an electrochemical device according to some embodiments.

FIG. 6 is a schematic diagram of a wound structure in an electrochemical device according to some embodiments.

FIG. 7 is a film structure diagram of a bending portion according to some embodiments.

FIG. 8 is a schematic diagram of a swelling process of an electrochemical device according to some embodiments.

FIG. 9 is a test result diagram of a convex region and a concave region according to some embodiments.

FIG. 10 is a schematic diagram of a height of a convex region protruding out of a peripheral zone of the convex region in a thickness direction of a positive electrode according to some embodiments.

FIG. 11 is a schematic test diagram of a density of a convex region on a second surface according to some embodiments.

FIG. 12 is a schematic diagram of a manufacturing process of a wound core of an electrochemical device according to some embodiments.

FIG. 13 is a schematic diagram of an entire structure and a partial structure of a wound core of an electrochemical device according to some embodiments.

FIG. 14 is a schematic diagram of a swelling process of an electrochemical device in some prior art.

FIG. 15 is a test diagram before cycling of an electrochemical device according to some embodiments.

FIG. 16 is a test diagram of a disassembled positive electrode after swelling of a negative electrode of an electrochemical device according to some embodiments.

FIG. 17 is a schematic cross-sectional view of electrochemical devices after cycling according to Example 1 and Comparative example 1.

FIG. 18 is a test result diagram of heights of a convex region at different stages according to Example 1.

### DETAILED DESCRIPTION

The following embodiments can help persons skilled in the art understand this application more comprehensively, but do not limit this application in any manner.

Apparently, the described embodiments are only some but not all embodiments of this application. Unless otherwise defined, all technical and scientific terms used herein shall have the same meanings as commonly understood by persons skilled in the art to which this application belongs. The terms used in the specification of this application are merely intended to describe specific embodiments rather than to limit this application.

The following describes some embodiments of this application in detail. However, this application may be embodied in many different implementations and should not be construed as being limited to the example embodiments set forth herein. Rather, these example embodiments are provided such that this application can be conveyed to persons skilled in the art thoroughly and in detail.

In addition, in the accompanying drawings, sizes or thicknesses of various components and layers may be exaggerated for brevity and clarity. Throughout the text, the same numerical values represent the same elements. As used herein, the term “and/or” includes any and all combinations of one or more associated items listed. In addition, it should be understood that when an element A is referred to as being “connected to” an element B, the element A may be directly connected to the element B, or an intervening element C may be present therebetween such that the element A and the element B are indirectly connected to each other.

Further, the use of “may” for describing embodiments of this application relates to “one or more embodiments of this application.”

The technical terms used herein are merely intended to describe specific embodiments rather than to limit this application. As used herein, the singular forms are intended to include the plural forms as well, unless otherwise clearly indicated in the context. It should be further understood that the term “include” used in this specification indicates the presence of stated features, numerical values, steps, operations, elements, and/or components but does not preclude the presence or addition of one or more other features, numerical values, steps, operations, elements, components, and/or combinations thereof.

Spatial related terms such as “above” may be used herein for ease of description to describe the relationship between one element or feature and another element (multiple elements) or feature (multiple features) as illustrated in the figure. It should be understood that the spatial related terms are intended to include different directions of equipment or a device in use or operation in addition to the directions described in the figures. For example, if the equipment in the figures is turned over, elements described as “over” or “above” other elements or features would then be oriented “beneath” or “below” the other elements or features. Thus, the example term “above” may include both directions of above and below. It should be understood that although the terms first, second, third, and the like may be used herein to describe various elements, components, regions, layers, and/or portions, these elements, components, regions, layers, and/or portions should not be limited by these terms. These terms are used to distinguish one element, component, region, layer, or portion from another element, component, region, layer, or portion. Therefore, the first element, component, region, layer, or portion discussed below may be referred to as the second element, component, region, layer, or portion without departing from the teachings of the example embodiments.

Some embodiments in this specification are described in a related manner. For a part that is the same or similar between these embodiments, reference may be made between these embodiments. Each embodiment focuses on differences from other embodiments. Apparently, the described embodiments are only some but not all embodiments of this application. All other technical solutions obtained by persons of ordinary skill in the art based on these embodiments of this application shall fall within the protection scope of this application. It should be noted that, in specific embodiments of this application, an example in which a lithium-ion battery is used as an electrochemical device is used to describe this application. However, the electrochemical device of this application is not limited to the lithium-ion battery.

In some embodiments of this application, an electrochemical device and an electronic device are provided. A gap is created between the positive electrode and the negative electrode to reserve a swelling space for the negative electrode, thereby releasing the cyclic swelling force, reducing the battery costs, and improving the cycling performance.

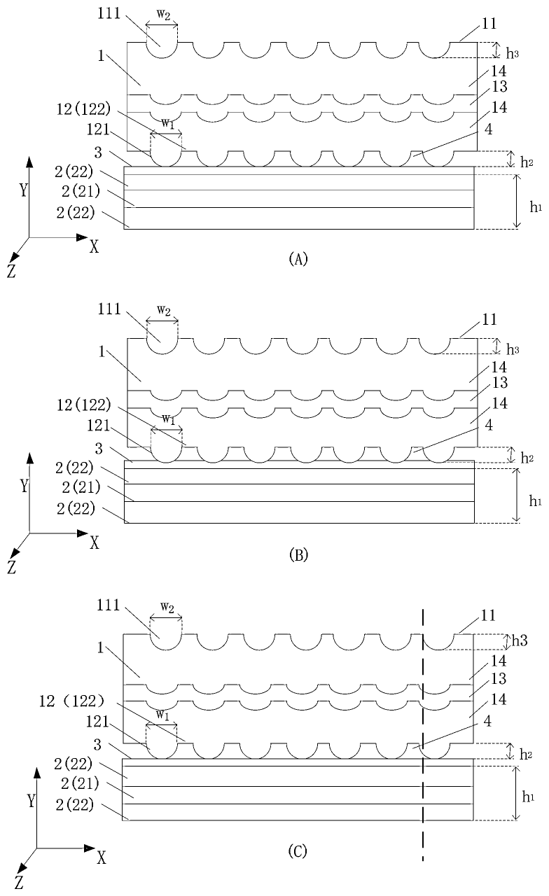

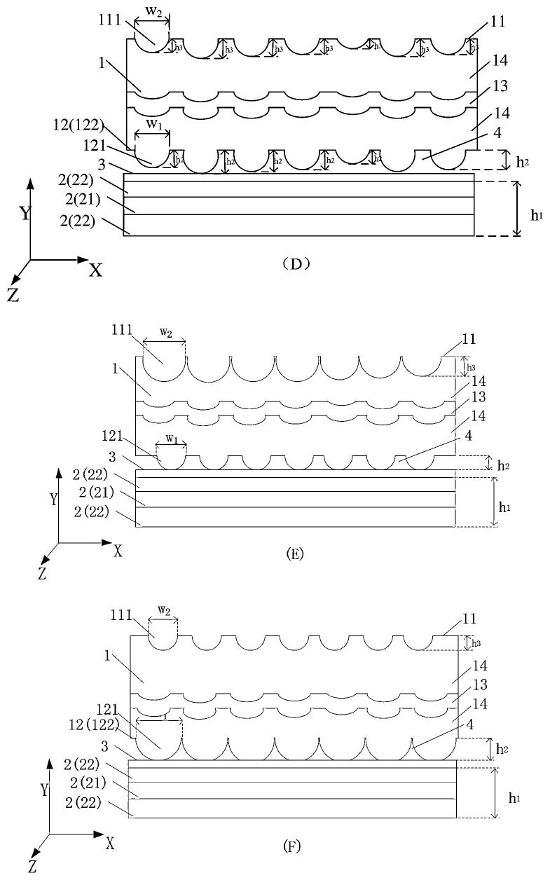

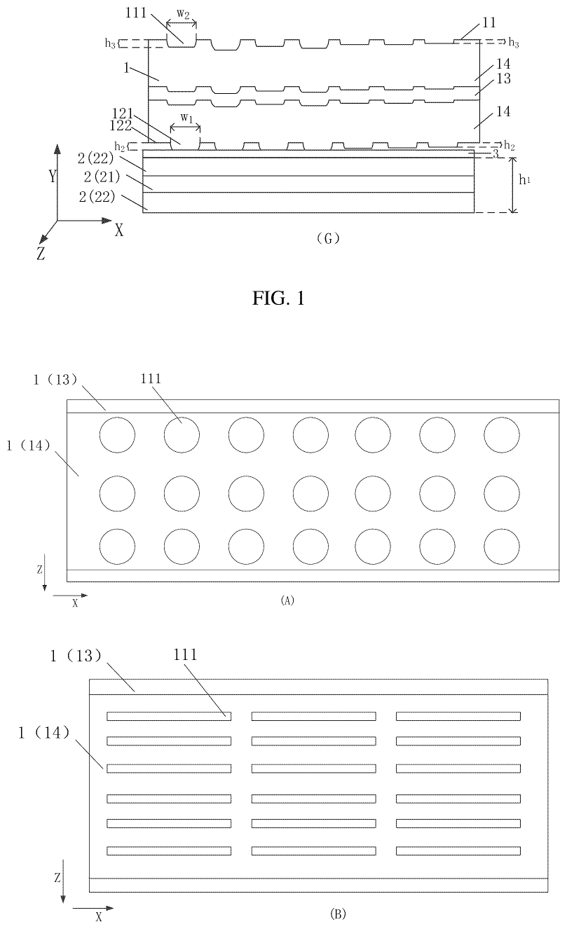

In some embodiments of this application, an electrochemical device is provided, as shown in FIG. 1. The electrochemical device includes a positive electrode 1, a negative electrode 2, and a separator 3 located between the positive electrode 1 and the negative electrode 2. The positive electrode 1 may include a positive electrode current collector 13 and a positive electrode active substance layer 14 located on one or two sides of the positive electrode current collector 13. For example, an aluminum foil may be used as the positive electrode current collector 13. The positive electrode active substance layer 14 may contain a positive electrode active substance, and the positive electrode active substance may include, for example, lithium cobalt oxide, lithium nickel oxide, or lithium manganese oxide. The negative electrode 2 may include a negative electrode current collector 21 and a negative electrode active substance layer 22 located on one or two sides of the negative electrode current collector 21. For example, a copper foil may be used as the negative electrode current collector 21. The negative electrode active substance layer may contain a negative electrode active substance, and the negative electrode active substance may be, for example, graphite or a silicon-containing material. A first surface 11 of the positive electrode 1 has a concave region 111, and a second surface 12 of the positive electrode 1 has a convex region 121 corresponding to the concave region 111 and protruding towards the negative electrode 2. A gap 4 is formed between the second surface 12 of the positive electrode 1 and the negative electrode 2 via the convex region 121. In some embodiments, the positive electrode 1 and the separator 3 may be in contact or may not be in contact, and the separator 3 and the negative electrode 2 may be in contact or may not be in contact. In some embodiments, when the separator 3 is attached to the negative electrode 2, the gap 4 between the positive electrode 1 and the negative electrode 2 may refer to a gap between the second surface 12 of the positive electrode 1 and the separator 3. When the separator 3 is attached to the second surface 12 of the positive electrode 1, the gap 4 between the positive electrode 1 and the negative electrode 2 may refer to a gap between the separator 3 and the negative electrode 2.

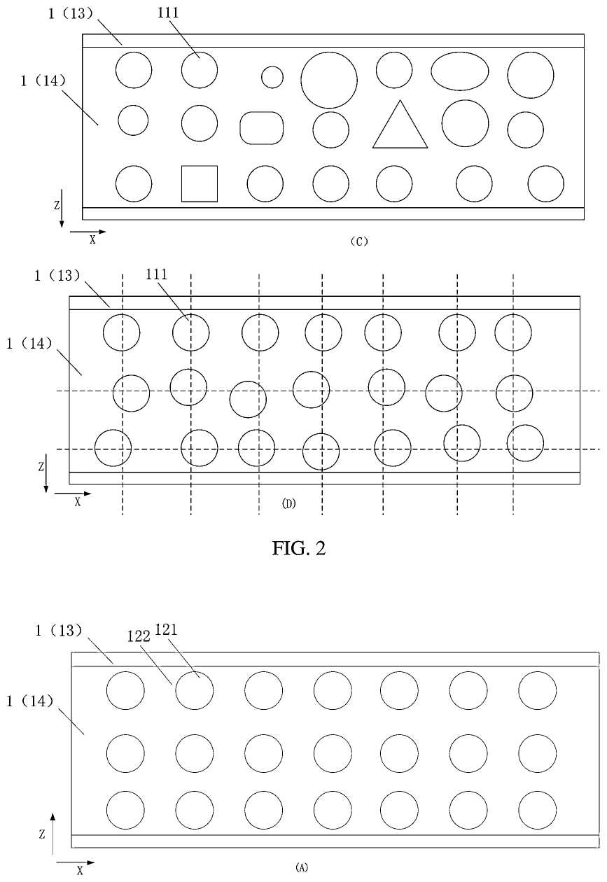

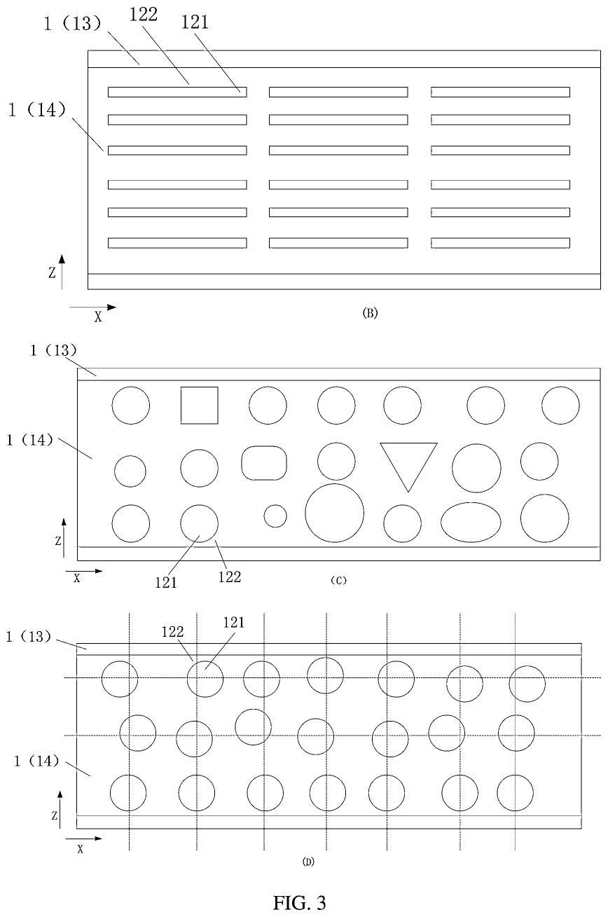

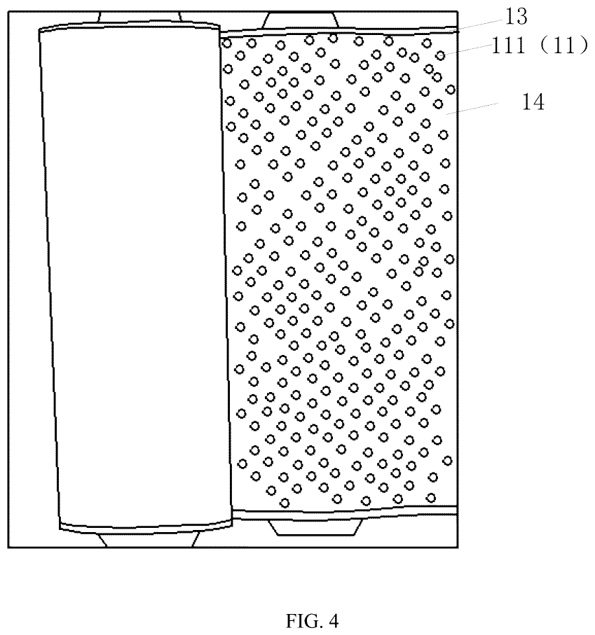

In some embodiments, as shown in FIGS. 1 and 2, the first surface 11 of the positive electrode 1 is concaved to form the concave region 111. In some embodiments, a partial region of the first surface 11 of the positive electrode 1 is concaved towards the second surface 12 of the positive electrode 1 to form the concave region 111. The concave region 111 and the convex region 121 may be in one-to-one correspondence or the concave region 111 and the convex region 121 may not be in one-to-one correspondence. In some embodiments, as shown in FIG. 1(A) to FIG. 1(C), the electrochemical device may be a wound electrochemical device, with direction X as a winding direction. Along the winding direction, the positive electrode 1 and the negative electrode 2 are bent. For example, the direction X may be a length direction of the positive electrode current collector 13. Direction Z is a direction perpendicular to both the directions X and Y, the direction Z may be a width direction of the positive electrode current collector 13, the direction Y is a thickness direction of the positive electrode 1, and the thickness direction of the positive electrode is a direction perpendicular to the positive electrode current collector. The concave region 111 and the corresponding convex region 121 may overlap or partially overlap in the thickness direction Y of the positive electrode 1. In some embodiments, because the convex region 121 protrudes out of a peripheral zone 122 of the convex region 121 on the second surface 12, and the peripheral zone 122 of the convex region 121 may at least be a zone surrounding the convex region 121 when viewed from the direction Y, the top of the convex region 121 is closer to the negative electrode 2 than the peripheral zone 122 of the convex region on the second surface 12 of the positive electrode 1. In some embodiments, as shown in FIG. 1(B), the convex region 121 may squeeze the separator 3, causing the top of the convex region 121 to be embedded into the separator 3. This can increase a contact area between the separator 3 and the convex region 121. When the negative electrode 2 swells, a uniform squeezing force can be applied to the convex region 121 via the separator 3, avoiding stress concentration causing cracks in the positive electrode active substance layer 14. In some embodiments, there may be multiple convex regions 121, and the gap 4 is formed between the second surface 12 of the positive electrode 1 and the negative electrode 2 via the convex region 121. In some embodiments, as shown in FIGS. 1(A) to (G), the size of the concave region 111 in the first surface 11 and the size of the convex region 121 on the second surface 12 may be the same or different. As shown in FIG. 1(D), the sizes of the concave regions 111 at different positions may be different. For example, depths h₃ of the concave regions 111 at different positions may be different, and widths W₂ of the concave regions 111 at different positions may be different, reducing the manufacturing difficulty. In some embodiments, because the sizes of the concave regions 111 are different, the amounts of electrolyte retained in these different concave regions 111 are different. Therefore, the size of the concave region 111 farther from an edge of the positive electrode active substance layer 14 in the direction X or Y may be larger. This is conducive for the concave region 111 closer to a central region of the positive electrode active substance layer 14 to better retain the electrolyte, facilitating the cycling performance. The sizes of the convex regions 121 at different positions may also be different. For example, heights h₂ of the convex regions 121 at different positions may be different, and widths W₁ of the convex regions 121 at different positions may be different. In some embodiments, when the heights of the convex regions 121 are different, different convex regions 121 may not contact the separator 3 simultaneously, thereby reducing the resistance to the flow of the electrolyte and providing a flow channel for the electrolyte, ensuring the infiltrability of the electrolyte to the positive electrode active substance layer 14. In some embodiments, a convex region 121 closer to the edge of the positive electrode active substance layer 14 in the direction X or direction Y has a smaller height h₂, thus preventing the convex region 121 close to the edge of the positive electrode active substance layer from blocking the electrolyte from flowing into the central region of the positive electrode active substance layer, facilitating the cycling performance. In some embodiments, when the size of the concave region 111 and the size of the convex region 121 are different, as shown in FIG. 1(D), the size of the concave region 111 may be larger than the size of the convex region 121. For example, the depth h₃ of the concave region 111 may be greater than the height h₂ of the convex region 121, and the width W₂ of the concave region 111 may be greater than the width W₁ of the convex region 121. When the convex region 121 is squeezed to shrink due to the swelling of the negative electrode 2, the size of the concave region 111 also decreases. Because the size of the concave region 111 is larger than the size of the convex region 121, when the convex region 121 is squeezed due to the swelling of the negative electrode 2, the concave region 111 can prevent the first surface 11 from protruding due to the squeezing of the convex region 121. In some other embodiments, as shown in FIG. 1(E), the size of the concave region 111 may be smaller than the size of the convex region 121. For example, the depth h₃ of the concave region 111 may be less than the height h₂ of the convex region 121, and the width W₂ of the concave region 111 may be less than the width W₁ of the convex region 121. In this case, the swelling of the negative electrode can also be buffered. In some embodiments, the depth difference between different concave regions 111 may be less than 3 m. In some embodiments, the height difference between different convex regions 121 may be less than 3 m. In some embodiments, FIG. 1(G) is a schematic diagram of an electrochemical device after cycling in FIG. 1(A), where it can be seen that the sizes of the convex region 121 and the concave region 111 decrease after cycling of the electrochemical device. This is because after the swelling of the negative electrode 2, the convex region 121 on the positive electrode 1 is squeezed, reducing the height h₂ of the convex region 121 and squeezing the concave region 111 inward, thereby reducing the internal space of the concave region 111. Because the height h₂ of the convex region 121 decreases, the gap between the positive electrode 1 and the negative electrode 2 decreases, thereby buffering the swelling generated during the cycling process. In some embodiments, FIG. 4 is a schematic diagram of the disassembled electrochemical device according to some embodiments of this application, and FIG. 2 is a schematic diagram of the first surface 11 of the positive electrode 1. As shown in FIG. 2, the concave region 111 is formed in the first surface 11 of the positive electrode. A cross section of the concave region 111 along the first surface 11 may be hemispherical, stripe-shaped, triangular, square, or polygonal, and the shape of the concave region 111 is not limited thereto. The shape of the cross section of the concave region 111 along the first surface 11 may be the same as the shape of a cross section of the convex region 121 along the second surface 12. FIG. 3 is a schematic diagram of the second surface 12 of the positive electrode, showing the shape of the convex region 121. The shape of the convex region 121 may be similar to the shape of the concave region 111 in FIG. 2. As shown in FIG. 3, the cross section of the convex region 121 along the first surface 11 may also be hemispherical, stripe-shaped, triangular, square, or polygonal, but is not limited thereto.

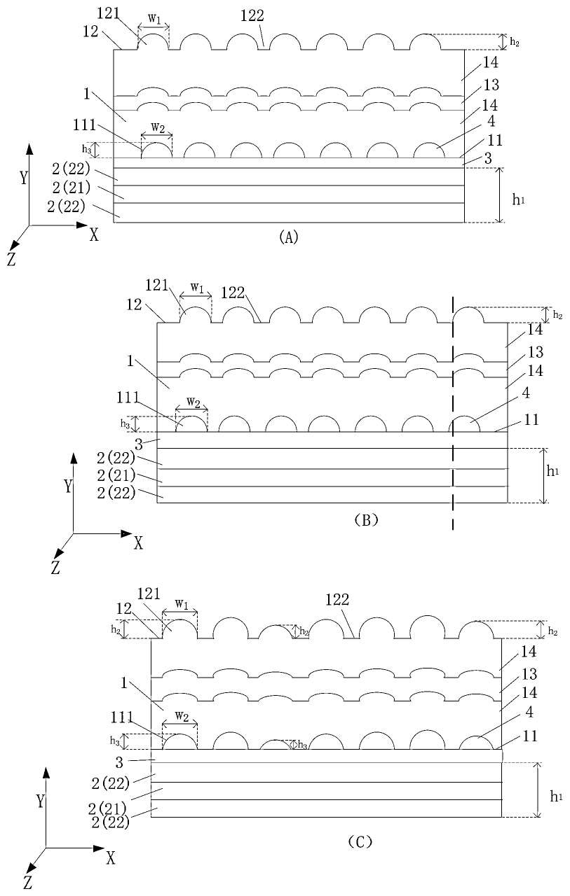

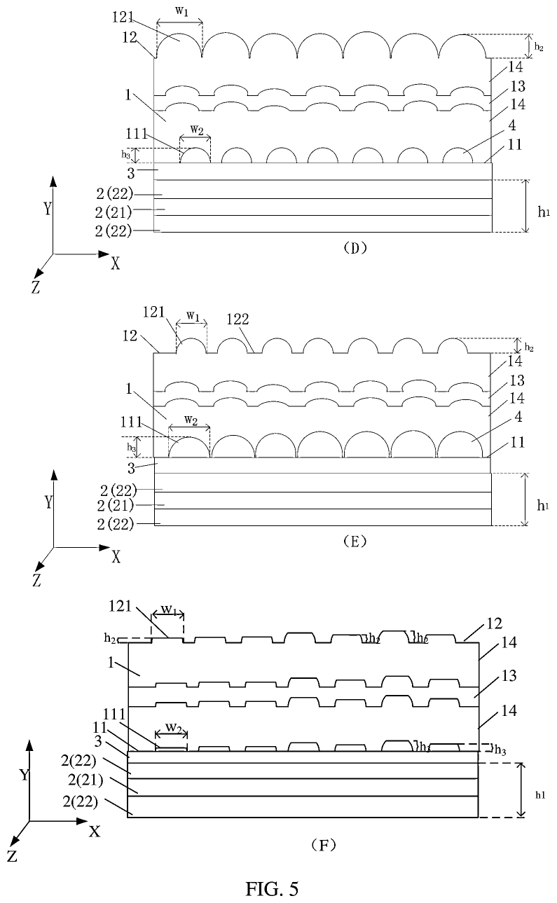

In some other embodiments of this application, as shown in FIG. 5, the electrochemical device includes a positive electrode 1, a negative electrode 2, and a separator 3 located between the positive electrode 1 and the negative electrode 2. The positive electrode 1 may include a positive electrode current collector 13 and a positive electrode active substance layer 14 located on one or two sides of the positive electrode current collector 13. The positive electrode active substance layer 14 may contain a positive electrode active substance, and the positive electrode active substance may include, for example, lithium cobalt oxide, lithium nickel oxide, or lithium manganese oxide. The negative electrode 2 may include a negative electrode current collector 21 and a negative electrode active substance layer 22 located on one or two sides of the negative electrode current collector 21. The negative electrode active substance layer may contain a negative electrode active substance, and the negative electrode active substance may be, for example, graphite or a silicon-containing material. The first surface 11 of the positive electrode 1 has a concave region 111, and the second surface 12 of the positive electrode 1 has a convex region 121 corresponding to the concave region 111. The convex region 121 protrudes towards a side away from the negative electrode 2. A gap 4 is formed between the first surface 11 of the positive electrode 1 and the negative electrode 2 via the concave region 111. In some embodiments, when the separator 3 is attached to the negative electrode 2, the gap 4 between the positive electrode 1 and the negative electrode 2 may refer to a gap between the positive electrode 1 and the separator 3, such as a gap formed between the concave region 111 and the separator 3. When the separator 3 is attached to the first surface 11 of the positive electrode 1 facing the negative electrode 2, the gap 4 between the positive electrode 1 and the negative electrode 2 may refer to a gap between the separator 3 and the negative electrode 2.

In some embodiments, in the electrochemical device shown in FIG. 5, the second surface 12 of the positive electrode 1 away from the negative electrode 2 has a convex region 121, and the first surface 11 of the positive electrode 1 facing the negative electrode 2 has a concave region 111. The concave region 111 corresponds to the convex region 121. Because the concave region 111 is concaved in the first surface 11 of the positive electrode 1, the other regions of the first surface 11 than the concave region 111 are closer to the negative electrode 2 than the concave region 111. Therefore, a gap 4 is formed between the positive electrode 1 and the negative electrode 2. The gap 4 may be an internal space of the concave region 111. In some embodiments, as shown in FIGS. 5(A) and 5(B), the concave region 111 and the convex region 121 can overlap or partially overlap in the thickness direction Y of the positive electrode 1. Thus, when the convex region 121 is squeezed to shrink, the size of the concave region 111 decreases, and the first surface 11 does not protrude. In some embodiments, as shown in FIGS. 5(A) to 5(F), the size of the concave region 111 in the first surface 11 and the size of the convex region 121 on the second surface 12 may be the same or different. For example, the depth h₃ of the concave region 111 may be the same as or different from the height h₂ of the convex region 121, and the width W₂ of the concave region 111 may be the same as or different from the width W₁ of the convex region 121. As shown in FIG. 5(C), the sizes of the concave regions 111 at different positions may be different. For example, depths h₃ of the concave regions 111 at different positions may be different, and widths W₂ of the concave regions 111 may be different, reducing the manufacturing difficulty. In some embodiments, because the sizes of the concave regions 111 are different, the amounts of electrolyte retained in these different concave regions 111 are different. Therefore, the size of the concave region 111 farther from an edge of the positive electrode active substance layer 14 in the direction X or Y may be larger, which is conducive for the concave region 111 closer to a central region of the positive electrode active substance layer 14 to better retain the electrolyte, facilitating the cycling performance. The sizes of the convex regions 121 at different positions may also be different. For example, the heights h₂ of the convex regions 121 at different positions may be different, and the widths W₁ of the convex regions 121 at different positions may be different. In some embodiments, when the heights of the convex regions 121 are different, the different convex regions 121 reduce the resistance to the flow of the electrolyte, providing a flow channel for the electrolyte, thus ensuring the infiltrability of the electrolyte to the positive electrode active substance layer 14. In some embodiments, a convex region 121 closer to the edge of the positive electrode active substance layer 14 in the direction X or direction Y has a smaller height h₂, thus preventing the convex region 121 close to the edge of the positive electrode active substance layer from blocking the electrolyte from flowing into the central region of the positive electrode active substance layer, facilitating the cycling performance. In some embodiments, when the size of the concave region 111 and the size of the convex region 121 are different, as shown in FIG. 5(D), the size of the convex region 121 may be larger than the size of the concave region 111. For example, the height h₂ of the convex region 121 may be greater than the depth h₃ of the concave region 111, and the width W₁ of the convex region 121 may be greater than the width W₂ of the concave region 111. When the convex region 121 is squeezed to shrink due to the swelling of the negative electrode 2, the size of the concave region 111 also decreases. Because the size of the concave region 111 is larger than the size of the convex region 121, when the convex region 121 is squeezed due to the swelling of the negative electrode 2, the concave region 111 can prevent the first surface 11 from protruding due to the squeezing of the convex region 121. As shown in FIG. 5(E), the size of the convex region 121 may be smaller than the size of the concave region 111. For example, the height h₂ of the convex region 121 may be smaller than the depth h₃ of the concave region 111, and the width W₁ of the convex region 121 may be smaller than the width W₂ of the concave region 111. In this case, the swelling of the negative electrode 2 can be buffered. In some embodiments, the difference in the depth h₃ between different concave regions 111 may be less than 3 μm. In some embodiments, the difference in the height h₂ between different convex regions 121 may be less than 3 μm. In some embodiments, FIG. 5(F) is a schematic diagram of the electrochemical device after cycling. It can be seen that after cycling of the electrochemical device, the sizes of the convex region 121 and the concave region 111 decrease, and the height h₂ of the convex region 121 and the depth h₃ of the concave region 111 decrease, thereby buffering the swelling generated during the cycling process.

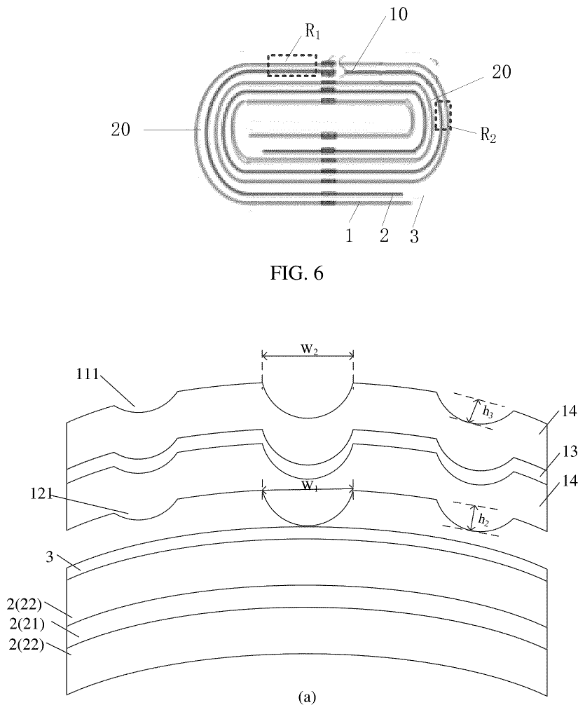

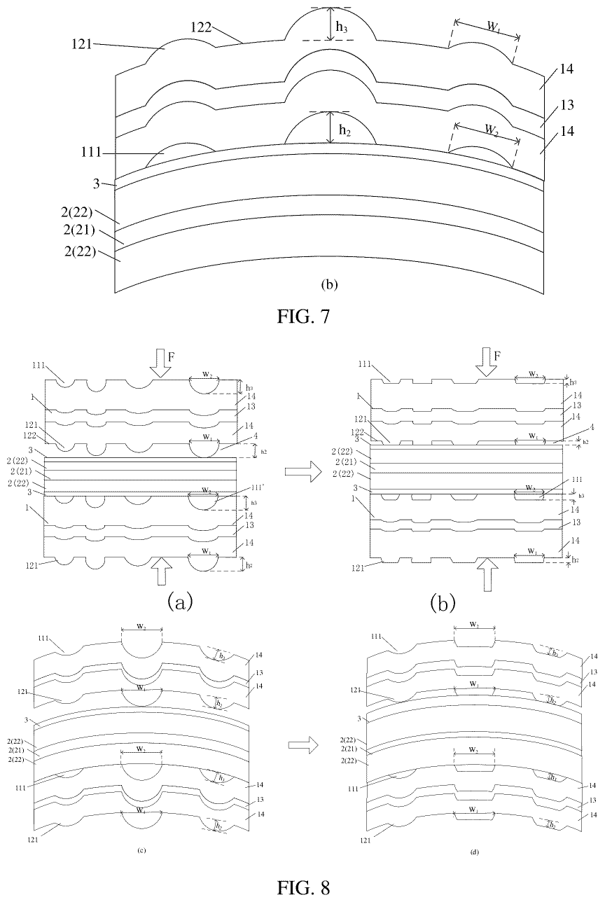

In some embodiments of this application, as shown in FIG. 6, the positive electrode 1, the negative electrode 2, and the separator 3 are wound to form a wound structure; and the wound structure includes a main body portion 10 and bending portions 20 located on two sides of the main body portion 10. FIGS. 1 and 5 may be film structure diagrams of the main body portion 10. For the bending portion 20, its film structure diagram may be FIG. 7. As shown in FIG. 7, at the bending portion, the positive electrode 1, the negative electrode 2, and the separator 3 are in a bent state. In some embodiments, FIG. 1 may be a schematic diagram of a region R₁ in the main body portion 10 in FIG. 6, and FIG. 5 may be a schematic diagram of a region R₂ in the bending portion 20.

In some embodiments, as shown in FIG. 8, when the electrochemical device of this application undergoes cycling, FIG. 8(a) and FIG. 8(b) show changes in the film structure of the main body portion 10 before and after cycling, and FIG. 8(c) and FIG. 8(d) show changes in the film structure of the bending portion 20 before and after cycling. As shown in FIG. 8(a), at the initial stage of the formation during charge and discharge, a pressure F (0.02 Mpa to 2 Mpa) may be applied. In addition, the negative electrode 2 has not yet swelled. In FIG. 8(a), the positive electrode 1 is disposed on two sides of the negative electrode 2. For the positive electrode 1 (the positive electrode 1 above the negative electrode 2 in FIG. 8(a)) on one side of the negative electrode 2, the surface of the positive electrode 1 facing the negative electrode has a convex region 121, and the surface of the positive electrode 1 away from the negative electrode 2 has a concave region 111. For the positive electrode 1 (the positive electrode 1 below the negative electrode 2 in FIG. 8(a)) on the other side of the negative electrode 2, the surface of the positive electrode 1 facing the negative electrode has a concave region 111, and the surface of the positive electrode 1 away from the negative electrode 2 has a convex region 121. During formation, the swelling force of the negative electrode 2 is released. As shown in FIG. 8(b), after the negative electrode 2 swells due to charge and discharge cycles, for the positive electrode 1 on one side of the negative electrode 2, the convex region 121 is squeezed by the negative electrode 2 when the negative electrode 2 swells, causing the height h₂ of the convex region 121 protruding out of the peripheral zone 122 of the convex region on the second surface 12 to decrease, thereby reducing the gap 4 between the positive electrode 1 and the negative electrode 2. The increased thickness on one side of the negative electrode 2 is approximately equal to the reduced height of the convex region 121. The squeezed convex region 121 moves towards the side away from the negative electrode 2. If there is no concave region 111, the squeezing of the convex region 121 may cause the surface of the positive electrode 1 away from the negative electrode to protrude. Because the concave region 111 overlaps or partially overlaps in the direction perpendicular to the thickness direction of the positive electrode 1, when the convex region 121 is squeezed, the depth and other dimensions of the concave region 111 gradually decrease, thereby alleviating or avoiding the protrusion of the surface of the positive electrode 1 away from the negative electrode 2. In this way, the internal stress generated during the swelling of the negative electrode 2 is released, and the deformation of the electrochemical device is alleviated or avoided. For the positive electrode on the other side of the negative electrode 2, when the negative electrode 2 swells, the positive electrode 1 is squeezed, and the convex region 121 on the side surface of the positive electrode 1 away from the negative electrode 2 may come into contact with a housing or other components of the electrochemical device, thereby reducing the height h₂ of the convex region 121. The concave region 111 corresponding to the convex region 121 prevents the surface of the positive electrode 1 facing the negative electrode 2 from protruding. The bending portion 20 of the electrochemical device is similar to the main body portion 10. As shown in FIG. 8(c), before the negative electrode 2 swells, a gap 4 is formed between the negative electrode 2 and the positive electrode 1 via the convex region 121 and the concave region 111. After the negative electrode swells due to cycling or other reasons, the convex region 121 is squeezed towards the positive electrode, causing the concave region 111 to decrease, thereby reducing the gap 4. The reduced gap 4 provides a buffer space for the swelling of the negative electrode 2. In some embodiments of this application, the swelling of the negative electrode 2 is buffered via the concave region 111 and the convex region 121, releasing the swelling force during the cycling process of the negative electrode, thereby alleviating or avoiding the deformation of the electrochemical device and improving the cycling effect. Additionally, the gap between the positive electrode 1 and the negative electrode 2 can absorb the electrolyte to increase the amount of the electrolyte between layers, improving the electrolyte retention between layers, and facilitating the cycling performance of the electrochemical device.

In some embodiments of this application, referring to FIG. 1 and FIG. 5, the height h₂ of the convex region 121 protruding out of the peripheral zone 122 of the convex region in the thickness direction Y of the positive electrode 1 is 2 μm to 40 μm. In some embodiments, the height h₂ of the convex region 121 protruding out of the peripheral zone 122 of the convex region in the thickness direction of the positive electrode 1 may refer to an average value of maximum heights of the convex regions 121 protruding out of the peripheral zones 122 of the convex regions. Ten convex regions 121 can be selected and tested for maximum heights, and then an average is calculated to obtain the height h₂ of the convex region 121. In some embodiments, when the height h₂ of the convex region 121 is in the range of 2 μm to 40 μm, the deformation of the electrochemical device can be reduced or avoided while a high volumetric energy density is obtained. In some embodiments, h₂ may be 5 μm, 10 μm, 15 μm, m, 25 μm, 30 μm, or 35 μm.

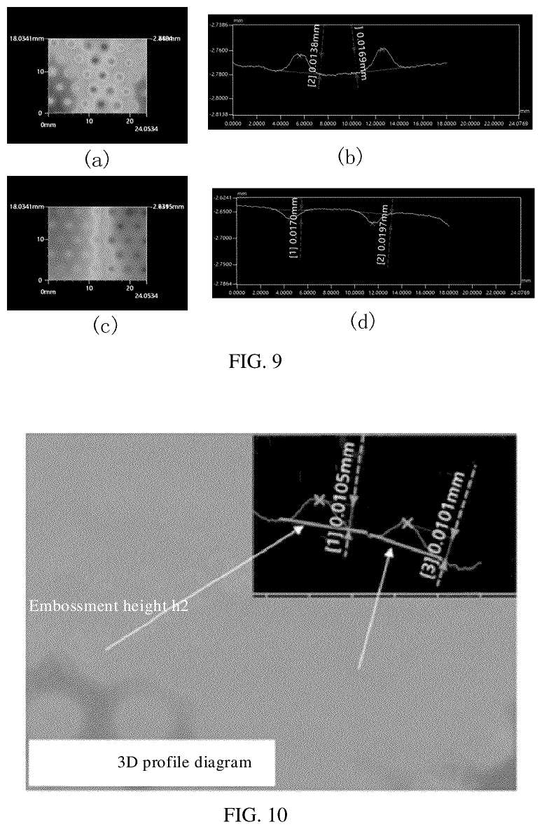

In some embodiments of this application, the height h₂ of the convex region 121 and the depth h₃ of the concave region 111 may be different, and the depth h₃ of the concave region 111 is greater than the height h₂ of the convex region 121. For example, 1.2h₂≥h₃≥1.08h₂. FIGS. 9(a) and 9(b) show test results of the height h₂ of the convex region 121 in a selected region of the main body portion 10 of the positive electrode 1, and FIGS. 9(c) and 9(d) show test results of the depth h₃ of the concave region 111 in the selected region. It can be seen that the depth h₃ of the concave region 111 is greater than the height h₂ of the convex region 121. In some embodiments, as shown in FIG. 9(a), a sample image is tested under a 3D imaging device, a line is drawn through the middle of the convex region in the image, and a height of each position on the line is tested. As shown in FIG. 9(b), a peak on the line is determined, peak bottoms on two sides of the peak are connected with a line, and a distance from the peak to the connecting line is the height h₂ of the convex region 121. The method for testing the depth h₃ of the concave region 111 is the same. As shown in FIG. 9(c), a sample image is tested under the 3D imaging device, a line is drawn through the middle of the concave region in the image, and a height of each position on the line is tested. As shown in FIG. 9(d), a valley on the line is determined, two sides of the top of the valley are connected with a connecting line, and a distance from the bottom of the valley to the connecting line is the depth h₃ of the concave region 111.

In some embodiments of this application, the height of the convex region 121 located on the main body portion 10 and protruding out of the peripheral zone 122 of the convex region in the thickness direction Y of the positive electrode 1 is different from the height of the convex region 121 located on the bending portion 20 and protruding out of the peripheral zone 122 of the convex region in the thickness direction Y of the positive electrode 1.

In some embodiments of this application, on the main body portion 10, the height h₂ of the convex region 121 protruding out of the peripheral zone 122 of the convex region in the thickness direction of the positive electrode 1 is 2 μm to 20 μm. In some embodiments, the negative electrode 2 during the swelling causes a decrease in the height h₂ of the convex region 121 protruding out of the peripheral zone 122 of the convex region in the thickness direction of the positive electrode 1, meaning that the height h₂ decreases with the increase in the number of cycles of the electrochemical device. Therefore, in some embodiments, the height h₂ of the convex region 121 protruding out of the peripheral zone 122 of the convex region in the thickness direction of the positive electrode 1 decreases, but the height h₂ of the convex region 121 can always be greater than zero. This ensures that there is always a certain gap 4 between the positive electrode 1 and the negative electrode 2, thereby always storing a certain amount of electrolyte, facilitating the cycling performance.

In some embodiments of this application, on the bending portion 20, the height h₂ of the convex region 121 protruding out of the peripheral zone 122 of the convex region in the thickness direction Y of the positive electrode 1 is 2 μm to 30 μm. For example, h₂ may be 5 μm, 10 μm, 15 μm, 20 μm, or 25 μm. In some embodiments, the height of the convex region 121 located on the bending portion 20 and protruding out of the peripheral zone 122 of the convex region in the thickness direction Y of the positive electrode 1 is 4 to 10 times, such as 5, 6, 7, 8, or 9 times, the height of the convex region 121 located on the main body portion 10 and protruding out of the peripheral zone 122 of the convex region in the thickness direction Y of the positive electrode 1. In some embodiments, the bending portion 20 bears smaller pressure generated due to the swelling than the main body portion 10. Therefore, when the negative electrode 2 swells, the reduced height of the convex region 121 is small. As a result, the convex region 121 on the bending portion 20 is higher than the convex region 121 on the main body portion 10.

In some embodiments of this application, the thickness of the negative electrode 2 before formation is h₀, the thickness of the negative electrode 2 after formation is h₁, the height of the convex region 121 located on the bending portion and protruding out of the peripheral zone 122 of the convex region in the thickness direction Y of the positive electrode 1 is h₂, and a swelling rate of the negative electrode 2 is δ, meeting h₂°h₀×δ. The swelling rate δ is related to the property of the negative electrode active material. For example, graphite typically has a swelling rate of 8% to 12%. After formation, the thickness of the negative electrode 2 and the thickness h₁ of the convex region meet 0.01h₁≤h₂≤0.03h₁. In some embodiments, h₀×δ represents the increased thickness of the negative electrode 2 due to the swelling, and the height h₂ of the convex region 121 on the bending portion is not less than the increased thickness of the negative electrode 2 due to the swelling, thereby ensuring the release of the internal stress generated due to the swelling of the negative electrode 2, avoiding deformation of the electrochemical device. In some embodiments, the thickness of the negative electrode is h₁, the height of the convex region 121 protruding out of the peripheral zone 122 of the convex region 121 in the thickness direction Y of the positive electrode 1 is h₂, and 0.0h₁≤h₂≤0.02h₁. The thickness h₁ of the negative electrode 2 is 100 μm to 180 μm. In some embodiments, the thickness h₁ of the negative electrode 2 is the thickness of the negative electrode 2 after the formation of the electrochemical device. The thickness h₁ of the negative electrode 2 is related to a cyclic swelling amount of the negative electrode 2. A greater thickness of the negative electrode 2 indicates a greater cyclic swelling amount and a higher requirement for the height h₂ of the convex region 121. Therefore, controlling the thickness of the negative electrode 2 to be within 100 μm to 180 μm can avoid an excessively large height h₂ of the convex region 121, reducing the processing difficulty.

In some embodiments, on the main body portion and the bending portion, the height h₂ of the convex region 121 protruding out of the peripheral zone 122 of the convex region in the thickness direction Y of the positive electrode 1 is measured as follows: The electrochemical device is disassembled and 4 cm×4 cm samples of the positive electrode are respectively taken from three different positions of the positive electrode 1 (for example, three different positions in the width direction). As shown in FIG. 10, the samples are placed under a 3D imaging device to test any position. The thickness (the height h₂ of an embossment in FIG. 10) of the convex region 121 is shown as uniform protruding points. The height h₂ can be obtained by comparing the highest position of the protruding points with the surrounding plane position, and then an average value is taken as the height h₂ of the convex region 121.

In some embodiments of this application, there may be a binder on the surface of the separator 3, and the binder includes at least one of polyvinylidene fluoride, carboxymethyl cellulose, polyacrylic acid, polyvinylpyrrolidone, polyaniline, polyimide, polyamide-imide, polysiloxane, styrene-butadiene rubber, epoxy resin, polyester resin, urethane resin, or polyfluorene. In some other embodiments of this application, there may be no binder on the surface of the separator 3. In some embodiments, because the deformation problem caused by the swelling of the negative electrode 2 is resolved, there is no need to use the separator 3 with a binder. Therefore, there is no need to use the separator 3 to alleviate the deformation of the electrochemical device, and the use of the separator 3 without a binder can reduce the costs of the electrochemical device.

In some embodiments of this application, a ceramic layer is provided on a surface of the separator 3. In some embodiments, the ceramic layer on the separator 3 can improve the insulation of the separator 3, prevent lithium dendrites from piercing the separator 3, and prolong the service life of the product. The ceramic layer may be a porous ceramic layer, thereby retaining the electrolyte, increasing the electrolyte retaining amount, and facilitating the cycling performance of the electrochemical device. The ceramic layer may be selected from at least one of aluminum oxide (Al₂O₃), silicon oxide (SiO₂), magnesium oxide (MgO), titanium oxide (TiO₂), hafnium dioxide (HfO₂), tin oxide (SnO₂), cerium dioxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate.

In some embodiments of this application, the separator 3 includes at least one of polypropylene, polyethylene, or a composite film of polypropylene and polyethylene.

In some embodiments of this application, the thickness h₃ of the separator 3 is 3 μm to 30 μm.

In some embodiments of this application, the peeling strength between the separator 3 and the positive electrode 1 is less than 0.5 N/m. In some embodiments, the peeling strength between the separator 3 and the positive electrode 1 is 0 N/m. In some embodiments, there is no binder on the surface of the separator 3, resulting in small peeling strength between the separator 3 and the positive electrode 1. This can reduce the probability of damage caused by the swelling of the negative electrode 2 and the shrinking of the convex region 121. In some embodiments, the peeling strength between the separator 3 and the positive electrode 1 can be measured as follows: A composite sheet is a stack of the positive electrode 1 and the separator 3, and a 3 mm×3 mm composite sheet is taken and tested using a mechanical tensile tester. The separator 3 is adhered and fixed to a platform and the mechanical tensile tester is connected to the positive electrode 1. A tensile force is applied to separate the positive electrode 1 from the separator 3, and the tensile force is recorded as the peeling strength between the separator 3 and the positive electrode 1. In some embodiments, the peeling strength between the separator 3 with a binder and the positive electrode 1 is greater than 3 N/m, and the peeling strength of the separator 3 without a binder is less than 0.5 N/m, approaching 0 N/m. In some embodiments of this application, at least two convex regions 121 are provided and the at least two convex regions 121 are evenly distributed on the second surface 12. In some embodiments, the convex regions 121 are evenly distributed, thereby reducing the probability of stress concentration, while the stress concentration may cause damage to the separator 3.

In some embodiments of this application, a density of the convex region 121 on the second surface is from 7 per square centimeter to 60 per square centimeter. In some embodiments, if the density of the convex region 121 is excessively small, it may be concaved due to force during the manufacturing process of the electrochemical device, failing to effectively form the gap 4. Conversely, an excessively large density of the convex region 121 may cause difficulty in manufacturing an embossing roller, increasing the preparation difficulty, and may lead to cracks in the positive electrode 1. In some embodiments, on the main body portion 10, the density of the convex region 121 on the second surface is from 8 per square centimeter to 50 per square centimeter. In some embodiments, on the bending portion, the density of the convex region 121 on the second surface 12 is from 8 per square centimeter to 40 per square centimeter. In some embodiments, on the main body portion 10, the density of the convex region 121 on the second surface 12 is from 8 per square centimeter to 30 per square centimeter. In some embodiments, on the main body portion 10, the density of the convex region 121 on the second surface 12 is from 8 per square centimeter to 20 per square centimeter. This can better ensure that the gap 4 between the positive electrode 1 and the negative electrode 2 matches the space required for the swelling of the negative electrode 2, thereby better releasing the swelling force.

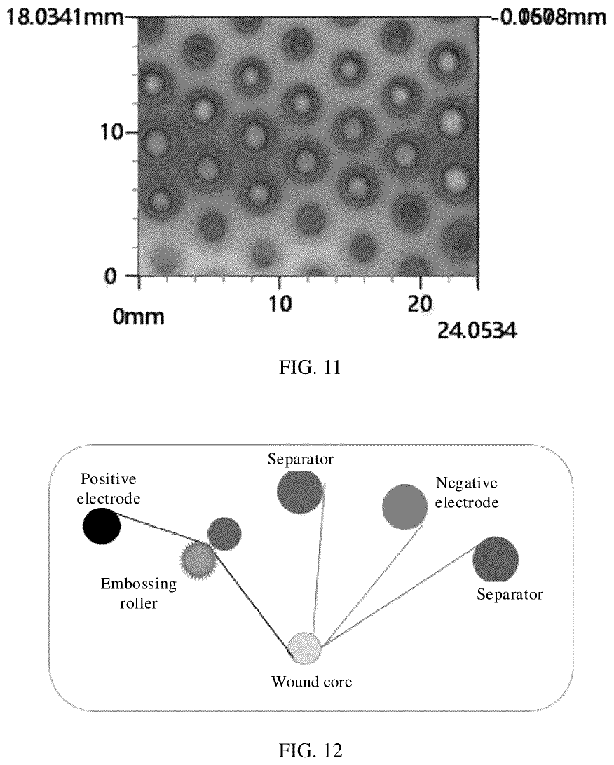

In some embodiments, the density of the convex region 121 on the second surface 12 can be tested as follows: A 40 mm×40 mm positive electrode sample is placed on a 3D Profile station, and a clamp is used to press the positive electrode sample to ensure that the sample is flat and smooth without wrinkles. A 3D Profile measurement system is used, with a magnification of ×12, and auto-focus measurement is performed. A plane is determined and scanned, and a profile function is turned on to display the size, morphology, and number of the convex regions 121 under measurement on the sample. In some embodiments, a test result of the positive electrode sample is shown in FIG. 11. Based on the read number of convex regions 121 in the test result and the area of the test region of the positive electrode sample, the density of the convex region 121 on the second surface 12 is calculated.

In some embodiments of this application, the convex region 121 is dot-shaped, stripe-shaped, or polygonal. The shape of the convex region 121 refers to a cross-sectional shape obtained by making a cross section of the convex region along the direction parallel to the second surface 12. The convex region 121 may also be of other shapes, which can be set as needed.

In some embodiments of this application, the positive electrode 1, the negative electrode 2, and the separator 3 are wound to form a wound structure. The wound structure includes a main body portion 10 and bending portions 20 located on two sides of the main body portion 10. In the main body portion 10, the surface of the negative electrode 2 facing the positive electrode 1 is a plane surface, and in the bending portion 20, the surface of the negative electrode 2 facing the positive electrode 1 is an arc surface. In some embodiments, a surface of the negative electrode 2 opposite the positive electrode 1 is a plane surface or an arc surface, so as to avoid the problem of uneven stress distribution in various regions caused by the uneven surface of the negative electrode 2. In some embodiments, the plane surface or arc surface may have some undulations. For example, when the undulations on the plane surface are not greater than 1 μm, it can be considered a plane surface.

In some embodiments, the convex region 121 or concave region 111 may deform under force. The convex region 121 and the concave region 111 may be each provided in a quantity not less than two. Therefore, the shapes of different convex regions 121 may vary, and the shapes of different concave regions 111 may also vary. After deformation under force, the top of the convex region 121 may become a plane surface or become a curved surface with a reduced curvature. Correspondingly, the inner bottom of the concave region 111 may also become a plane surface or a curved surface with a reduced curvature.

In some embodiments, the sizes of the convex region 121 and the concave region 111 may not be exactly the same. In some embodiments, the size of the concave region 111 in the first surface 11 may be larger than the size of the corresponding convex region 121 on the second surface 12. In some embodiments, the size of the concave region 111 in the first surface 11 may be smaller than the size of the convex region 121 on the second surface 12.

In some embodiments, the size of the convex region 121 may include the height h₂ of the convex region 11 in the thickness direction of the positive electrode 1 and the width W₁ of the convex region 121 in the direction parallel to the positive electrode 1. The size of the concave region 111 may include the depth h₃ of the concave region 111 in the thickness direction of the positive electrode 1 and the width W₂ of the concave region 111 in the direction parallel to the positive electrode 1.

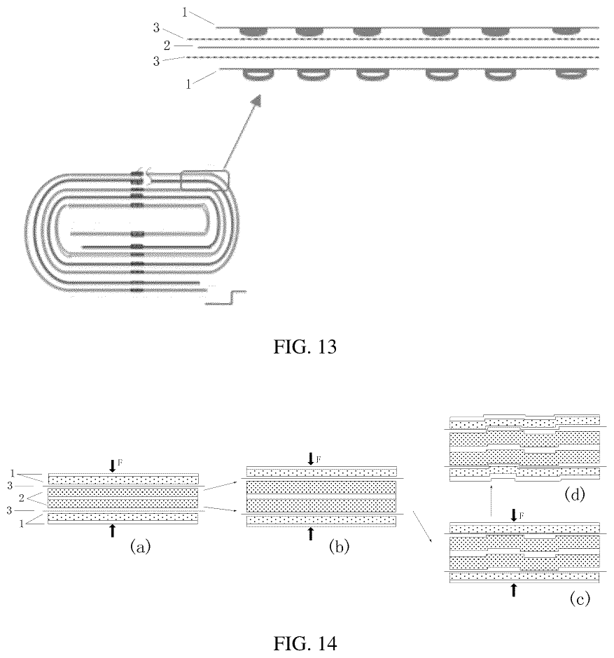

In some embodiments of this application, the positive electrode 1 can be prepared as follows: As shown in FIG. 12, an embossing process is used to create embossments with a certain thickness on the positive electrode 1. Specifically, the positive electrode 1 is rolled with an embossing roller and a rubber roller, with a set pressure value (0.02 Mpa to 0.9 Mpa). Before winding, the positive electrode 1 is passed through the embossing roller and the rubber roller, forming embossments with a certain thickness thereon to form the convex regions 121. The height h₂ of the convex region 121 may be 2 μm to 40 μm, preferably 2 μm to 20 μm. The positive electrode 1, the negative electrode 2, and the separator 3 are wound to form a wound core. In some other embodiments, the positive electrode 1, the negative electrode 2, and the separator 3 may be stacked together. FIG. 13 is a schematic diagram of a prepared wound core and a local part of the wound core, and FIGS. 1 and 5 may be schematic diagrams of the local part selected from the wound core in FIG. 13. It can be seen that a gap is formed between the positive electrode 1 and the negative electrode 2.

In some embodiments of this application, the positive electrode 1 has convex regions 121 with a certain thickness, such that a gap 4 is formed between the positive electrode 1 and the negative electrode 2, and during charge and discharge, the swelling force in the negative electrode 2 can be released, resolving the deformation problem of the electrochemical device. Therefore, a separator 3 without an adhesion layer can be used to reduce the costs. The involved gap can additionally retain the electrolyte and increase electrolyte infiltration between layers, improving long cycles and achieving a gain effect.

In some embodiments of this application, the negative electrode 2 includes a negative electrode current collector and a negative electrode active substance layer located on the negative electrode current collector. The negative electrode active substance layer includes a negative electrode material. The negative electrode material includes at least one of graphite, silicon, silicon-based material, silicon-carbon composite, or metal. In some embodiments, the negative electrode active substance layer may further include a conductive agent and a binder. In some embodiments, the conductive agent in the negative electrode active substance layer may include at least one of conductive carbon black, Ketjen black, laminated graphite, graphene, carbon nanotubes, or carbon fiber. In some embodiments, the binder in the negative electrode active substance layer may include at least one of carboxymethyl cellulose (CMC), polyacrylic acid, polyvinylpyrrolidone, polyaniline, polyimide, polyamideimide, polysiloxane, styrene-butadiene rubber, epoxy resin, polyester resin, polyurethane resin, or polyfluorene. In some embodiments, a mass ratio of the negative electrode material, the conductive agent, and the binder in the negative electrode active substance layer may be (78-98.5):(0.1-10):(0.1-10). The negative electrode material may be a mixture of a silicon-based material and another material. It should be understood that the foregoing description is only exemplary. Any other appropriate materials and mass ratios may be used. In some embodiments, at least one of a copper foil, a nickel foil, or a carbon-based current collector may be used as the negative electrode current collector.

In some embodiments, the positive electrode 1 includes a positive electrode current collector 13 and a positive electrode active substance layer 14 disposed on the positive electrode current collector 13. The positive electrode active substance layer 14 may include a positive electrode material. In some embodiments, the concave region 111 may be located in the positive electrode active substance layer 14. In some embodiments, the convex region 121 may be located on the positive electrode active substance layer 14. In some embodiments, the positive electrode current collector 13 may also have a concave region 111. In some embodiments, the positive electrode current collector may also have a convex region 121. In some embodiments, the positive electrode material includes at least one of lithium cobalt oxide, lithium iron phosphate, lithium manganese iron phosphate, sodium iron phosphate, lithium vanadium phosphate, sodium vanadium phosphate, lithium vanadyl phosphate, sodium vanadyl phosphate, lithium vanadate, lithium manganese oxide, lithium nickel oxide, lithium nickel cobalt manganate, lithium-rich manganese-based material, or lithium nickel cobalt aluminate. In some embodiments, the positive electrode active substance layer may further include a conductive agent. In some embodiments, the conductive agent in the positive electrode active substance layer 14 may include at least one of conductive carbon black, Ketjen black, laminated graphite, graphene, carbon nanotubes, or carbon fiber. In some embodiments, the positive electrode active substance layer 14 may further include a binder, and the binder in the positive electrode active substance layer 14 may include at least one of carboxymethyl cellulose (CMC), polyacrylic acid, polyvinylpyrrolidone, polyaniline, polyimide, polyamideimide, polysiloxane, styrene-butadiene rubber, epoxy resin, polyester resin, polyurethane resin, or polyfluorene. In some embodiments, a mass ratio between a positive electrode material, a conductive agent, and a binder in the positive electrode active substance layer 14 may be (80 to 99):(0.1 to 10):(0.1 to 10). In some embodiments, a thickness of the positive electrode active substance layer 14 may range from 10 μm to 500 μm. It should be understood that the foregoing description is only exemplary, and any other suitable materials, thicknesses, and mass ratios may be adopted for the positive electrode active substance layer 14.

In some embodiments, the positive electrode current collector 13 may be an Al foil, or certainly may be another current collector commonly used in the art. In some embodiments, a thickness of the positive electrode current collector 13 may range from 1 μm to 50 μm. In some embodiments, the positive electrode active substance layer 14 may be applied to only a partial region of the positive electrode current collector 13.

In some embodiments of this application, the electrochemical device is a wound type. In some embodiments, the positive electrode and/or the negative electrode of the electrochemical device may be a multi-layer structure formed through winding, or may be a single-layer structure formed by winding a single-layer positive electrode, a separator, and a single-layer negative electrode.

In some embodiments, the electrochemical device includes a lithium-ion battery, but this application is not limited thereto. In some embodiments, the electrochemical device may further include an electrolyte. The electrolyte may be one or more of gel electrolyte, solid electrolyte, and liquid electrolyte, and the liquid electrolyte includes a lithium salt and a non-aqueous solvent. The lithium salt is selected from one or more of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, LiPF₆ is used as the lithium salt. The non-aqueous solvent may be a carbonate compound, an ester-based compound, an ether-based compound, a ketone-based compound, an alcohol-based compound, a non-proton solvent, or a combination thereof. The carbonate compound may be a linear carbonate compound, a cyclic carbonate compound, a fluorocarbonate compound, or a combination thereof.

An example of the linear carbonate compound is diethyl carbonate (DEC), dimethyl carbonate (DMC), dipropyl carbonate (DPC), methyl propyl carbonate (MPC), ethylene propyl carbonate (EPC), ethyl methyl carbonate (MEC), or a combination thereof. An example of the cyclic carbonate compound is ethylene carbonate (EC), propyl carbonate (PC), butyl carbonate (BC), vinyl ethyl carbonate (VEC), or a combination thereof. An example of the fluorocarbonate compound is fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

An example of the carboxylate compound is methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, methyl formate, or a combination thereof.

An example of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, or a combination thereof.

An example of the another organic solvent is dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or a combination thereof.

In some embodiments of this application, a lithium-ion battery is used as an example. A positive electrode 1, a separator 3, and a negative electrode 2 are wound in sequence to form an electrode assembly, and the electrode assembly is then packaged in an aluminum-plastic film, followed by injection of an electrolyte, formation, and packaging, such that the lithium-ion battery is prepared. Then, a performance test is performed on the prepared lithium-ion battery.

Those skilled in the art will understand that the method for preparing the electrochemical device (for example, the lithium-ion battery) described above is only an example. Without departing from the content disclosed in this application, other methods commonly used in the art may be used.

Some embodiments of this application further provide an electronic device including the foregoing electrochemical device. The electronic device in these embodiments of this application is not particularly limited, and may be any known electronic device used in the prior art. In some embodiments, the electronic device may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a drone, a lighting appliance, a toy, a game console, a clock, an electric tool, a flash lamp, a camera, a large household battery, a lithium-ion capacitor, and the like.

In the prior art, the separator in the electrochemical device (for example, a lithium-ion battery) usually has an adhesion layer, and the strong adhesion effect of the adhesion layer on the separator can prevent deformation of the negative electrode after swelling. However, using an adhesion layer on the separator increases the costs, raising the costs by about 4% as compared with a separator without an adhesion layer. Additionally, to ensure that the electrochemical device does not deform in the mid-to-late stage of cycling, external pressure needs to be applied in the mid-to-late stage of cycling, further increasing the costs.

If a separator without an adhesion layer is used directly, as shown in FIG. 14(a), before formation, the positive electrode 1, the negative electrode 2, and the separator 3 are stacked, with an external force F applied. After formation, as shown in FIG. 10(b), the negative electrode 2 swells. As the cycling progresses, as shown in FIG. 14(c), due to the lack of an adhesion layer, after the internal stress of the negative electrode 2 is released, because there is no extra space to absorb the swelling force of the negative electrode 2, the negative electrode 2 shows significant wrinkles. After formation, with the external force F removed, as shown in FIG. 14(d), the entire electrochemical device deforms, deteriorating the cycling performance. In the electrochemical device proposed in these embodiments of this application, a gap is formed between the positive electrode 1 and the negative electrode 2 via the convex region 121, reserving a swelling space for the negative electrode 2 and releasing the cyclic swelling force. This avoids deformation caused by cyclic swelling, increases the electrolyte retaining amount, and improves the cycling performance.

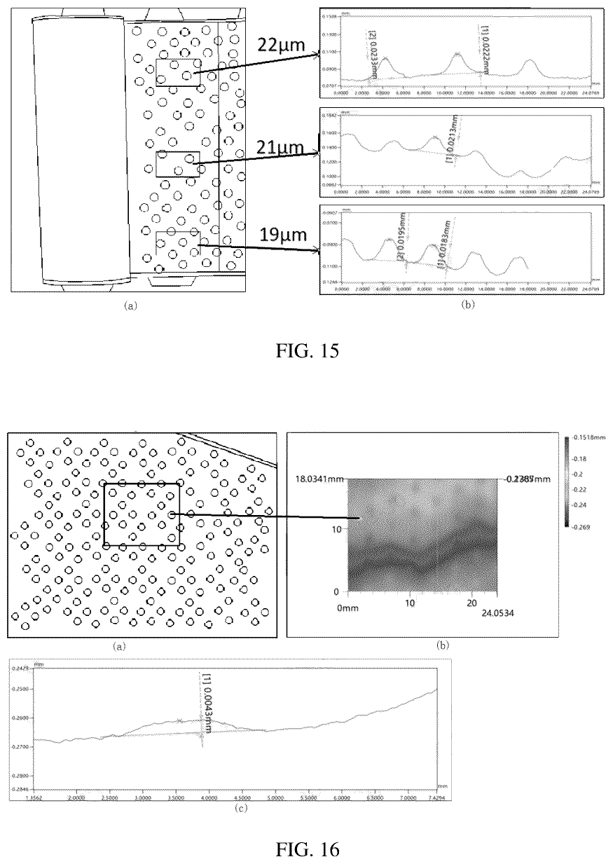

In some embodiments of this application, as shown in FIGS. 15 and 16, FIGS. 15 and 16 are test diagrams of the positive electrode before and after the swelling of the negative electrode of the electrochemical device. In FIG. 15(a), three regions (square regions) are selected on the positive electrode 1, and heights of convex regions 121 in the three regions are measured as 22 μm, 21 μm, and 19 μm, respectively. As shown in FIG. 16, after the electrochemical device cycles (after the negative electrode 2 swells), it is disassembled. FIG. 16(a) is a schematic diagram of the positive electrode 1. FIG. 13(b) shows a height change test of the region selected in FIG. 13(a), and the test result is shown in FIG. 13(c). It can be seen that after the negative electrode swells, the height of the convex region 121 decreases to 3 μm to 4 μm. This is because the swelling negative electrode 2 during the cycling process squeezes the convex region 121, reducing the height of the convex region 121.

To further demonstrate the technical effects of this application, the electrochemical device proposed in this application is compared with an electrochemical device in a comparative example.

### Example 1

### Preparation of Positive Electrode

Lithium cobalt oxide, acetylene black, and polyvinylidene fluoride were mixed well in a ratio of 96:2.8:1.2, in which an appropriate amount of N-methylpyrrolidone was added and stirred fully, so as to prepare a uniform slurry. The uniform slurry was applied to an Al foil (a positive electrode current collector), dried, and cold-pressed to obtain a positive electrode plate with a thickness of 187 μm.

### Preparation of Negative Electrode

Negative electrode material artificial graphite, styrene-butadiene rubber, and sodium carboxymethyl cellulose were mixed well in a weight ratio of 97:2:1, in which an appropriate amount of deionized water was added and stirred fully, so as to prepare a uniform slurry. The uniform slurry was applied to a Cu foil (a negative electrode current collector), dried, and cold-pressed to obtain a negative electrode plate with a thickness of 139 μm.

Preparation of lithium-ion battery: A 20 μm polypropylene (PP) film was used as a separator, and the prepared positive electrode plate, the separator, and the negative electrode plate were stacked in sequence, welded with tabs, rolled, and wound to obtain an electrode assembly. The electrode assembly was placed in a packaging shell, followed by injection of an electrolyte and packaging, to obtain a lithium-ion battery, which was subjected to formation at a formation pressure of 0.3 MPa.

During a rolling process, an embossing roller was used. The pressure was set to 0.3 MPa, a convex region with a height of 30 m was formed on one surface of the positive electrode plate facing the negative electrode plate, and a corresponding concave region was formed in the other surface.

### Comparative Example 1

The difference between Comparative example 1 and Example 1 was only that the embossing roller was not used during the rolling process, and the positive electrode plate was provided with no convex region and concave region.

### Cycling Test

The lithium-ion battery was charged and discharged for the first time in an environment at 25° C. The battery was constant-current charged at a charging current of 1 C to 3.65V, constant-voltage charged at 3.65V to 0.05 C, and left standing for 10 min. The battery was constant-current discharged at a discharging current of 1 C until the final voltage reached 2.58V, and left standing for 10 min. The discharge capacity of the first cycle was recorded. The above steps were repeated for 500 charge and discharge cycles. After the cycling was completed, the lithium-ion battery was disassembled to observe whether the electrode assembly had any wrinkle.

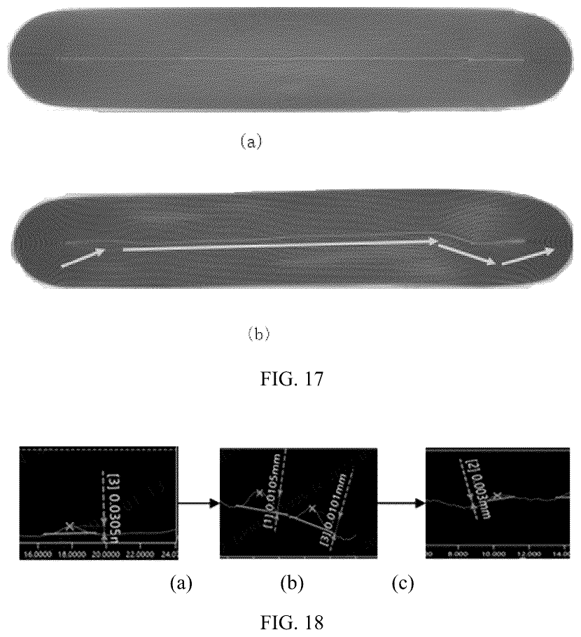

In some embodiments, FIG. 17(a) and FIG. 17(b) are schematic cross-sectional views of electrode assemblies in electrochemical devices according to Example 1 and Comparative example 1. FIG. 17(a) is a schematic cross-sectional view of the electrochemical device of Example 1. The wound electrode assembly shown in FIG. 17(a) is merely an application example and does not impose any limitations on this application. The shape of the electrode assembly in this application is not limited to the shape shown in FIG. 14, and the electrode assembly in this application may have no bending portion shown in FIG. 17. As can be seen from FIGS. 17(a) and 17(b), during the use of the electrochemical device proposed in this application, the swelling stress of the negative electrode is absorbed by the gap between the positive electrode and the negative electrode, and thus the electrode assembly almost does not deform. During the direct use of a separator without an adhesion layer, but without the electrochemical device proposed in this application, because there is no convex region or concave region to buffer the swelling of the electrode assembly, as shown in FIG. 17(b), the electrode assembly in Comparative example 1 deforms significantly. Through parallel experiments, the height of the convex region in the lithium-ion battery of Example 1 was tested after preparation, formation, and 500 cycles. The test result is shown in FIG. 18(a). The height of the convex region was 30 m before the formation of the lithium-ion battery. As shown in FIG. 18(b), the height of the convex region is 10 m after the formation of the lithium-ion battery. As shown in FIG. 18(c), the height of the convex region was 3 m after 500 cycles of the lithium-ion battery. Due to the reduced height of the convex region, the swelling of the lithium-ion battery is buffered.

The above description is merely some preferred embodiments of this disclosure and explanations of the applied technical principles. It should be understood by those skilled in the art that the scope of the invention involved in embodiments of this disclosure is not limited to the specific combinations of the technical features described above, but also includes other technical solutions formed by any combination of the above technical features or their equivalent features without departing from the inventive concept described above. For example, the above features can be replaced with technical features disclosed in these embodiments of this disclosure (but not limited to) that have similar functions to form other technical solutions.

What is claimed is:

1. An electrochemical device, comprising a positive electrode, a negative electrode, and a separator located between the positive electrode and the negative electrode; wherein
a first surface of the positive electrode has a concave region, a second surface of the positive electrode has a convex region corresponding to the concave region; and a gap is formed between the second surface of the positive electrode and the negative electrode via the convex region, or a gap is formed between the first surface of the positive electrode and the negative electrode via the concave region.

2. The electrochemical device according to claim 1, wherein a thickness of the negative electrode is h₁, a height of the convex region protruding out of a peripheral zone of the convex region in a thickness direction of the positive electrode is h₂, and 0.01h₁≤h₂≤0.03h₁.

3. The electrochemical device according to claim 1, wherein a thickness of the negative electrode is h₁, a height of the convex region protruding out of a peripheral zone of the convex region in a thickness direction of the positive electrode is h₂, and 0.01h₁≤h₂≤0.02 h₁.

4. The electrochemical device according to claim 2, wherein the thickness h₁ of the negative electrode is 100 μm to 180 μm.

5. The electrochemical device according to claim 1, wherein
a height h₂ of the convex region protruding out of a peripheral zone of the convex region in a thickness direction of the positive electrode is 2 μm to 40 μm.

6. The electrochemical device according to claim 1, wherein the positive electrode, the negative electrode, and the separator are wound to form a wound structure; and the wound structure comprises a main body portion and bending portions located on two sides of the main body portion, and meets at least one of the following conditions:
(a) on the main body portion, a height h₂ of the convex region protruding out of a peripheral zone of the convex region in a thickness direction of the positive electrode is 2 μm to 20 μm;
(b) on the bending portion, a height h₂ of the convex region protruding out of a peripheral zone of the convex region in a thickness direction of the positive electrode is 2 μm to 30 μm; or
(c) a height of the convex region located on the bending portion and protruding out of a peripheral zone of the convex region in a thickness direction of the positive electrode is 4 times to 10 times a height of the convex region located on the main body portion and protruding out of a peripheral zone of the convex region in the thickness direction of the positive electrode.

7. The electrochemical device according to claim 6, wherein on the main body portion, the height h₂ of the convex region protruding out of the peripheral zone of the convex region in the thickness direction of the positive electrode is 2 μm to 10 μm.

8. The electrochemical device according to claim 6, wherein on the main body portion, the height h₂ of the convex region protruding out of the peripheral zone of the convex region in the thickness direction of the positive electrode is 2 μm to 5 μm.

9. The electrochemical device according to claim 6, wherein on the bending portion, the height h₂ of the convex region protruding out of the peripheral zone of the convex region in the thickness direction of the positive electrode is 5 μm to 30 μm.

10. The electrochemical device according to claim 6, wherein on the bending portion, the height h₂ of the convex region protruding out of the peripheral zone of the convex region in the thickness direction of the positive electrode is 10 μm to 30 μm.

11. The electrochemical device according to claim 1, wherein at least one of the following conditions is met:
(a) a ceramic layer is provided on a surface of the separator;
(b) the separator comprises at least one of polypropylene, polyethylene, or a composite film of polypropylene and polyethylene; or
(c) a thickness h₃ of the separator is 3 μm to 30 μm.

12. The electrochemical device according to claim 11, wherein a peeling strength between the separator and the positive electrode is less than 0.5 N/m.

13. The electrochemical device according to claim 1, wherein a peeling strength between the separator and the positive electrode is 0 N/m.

14. The electrochemical device according to claim 1, wherein
at least two convex regions are provided and the at least two convex regions are evenly distributed on the second surface.

15. The electrochemical device according to claim 14, wherein 7 to 60 convex regions are provided per square centimeter of the second surface.

16. The electrochemical device according to claim 6, wherein on the bending body portion, 8 to 50 convex regions are provided per square centimeter of the second surface.

17. The electrochemical device according to claim 6, wherein on the main body portion, 8 to 30 convex regions are provided per square centimeter of the second surface.

18. The electrochemical device according to claim 1, wherein the convex region is dot-shaped, stripe-shaped, or polygonal shaped.

19. The electrochemical device according to claim 1, wherein the positive electrode, the negative electrode, and the separator are wound to form a wound structure; and the wound structure comprises a main body portion and bending portions located on two sides of the main body portion; wherein
in the main body portion, a surface of the negative electrode facing the positive electrode is a plane surface; and
in the bending portion, a surface of the negative electrode facing the positive electrode is an arc surface.

20. An electronic device, comprising an electrochemical device, the electrochemical device comprising a positive electrode, a negative electrode, and a separator located between the positive electrode and the negative electrode; wherein
a first surface of the positive electrode has a concave region, a second surface of the positive electrode has a convex region corresponding to the concave region; and a gap is formed between the second surface of the positive electrode and the negative electrode via the convex region, or a gap is formed between the first surface of the positive electrode and the negative electrode via the concave region.
